(19) United States
(12) Patent Application Publication
(10) Pub. No.: US 2009/0189369 A1
(43) Pub. Date: Jul. 30, 2009

(54) HITCH BALL MOUNT ASSEMBLY HAVING A BIOMETRIC ENGAGEMENT MECHANISM

(75) Inventor: Donald A. Thomas, Columbiana, OH (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: DONALD THOMAS LLC, Columbiana, OH (US)

(21) Appl. No.: 12/260,469

(22) Filed: Oct. 29, 2008

Related U.S. Application Data
(60) Provisional application No. 60/983,402, filed on Oct. 29, 2007.

(51) Int. Cl. B60D 1/60

(52) U.S. Cl. 280/507; 280/511

(57) ABSTRACT

A hitch ball mount assembly includes a biometrically-actuated locking mechanism. The biometrically-actuated locking mechanism cooperates with a mechanical engagement mechanism to lock or unlock the hitch ball mount assembly to an associated vehicle mount in response to detection of an authorized user.

### RELATED APPLICATION DATA

This application claims priority of U.S. Provisional Application No. 60/983,402, filed on Oct. 29, 2007, which is incorporated herein by reference in its entirety.

### TECHNICAL FIELD OF THE INVENTION

The present invention relates generally to tow hitch equipment, and, more particularly, to a tow hitch ball mount assembly having a biometrically-actuated engagement mechanism.

### BACKGROUND

Each day over a million trailers are towed on the nation's highways. With over a million trailers being towed on the nation's highways, million's of dollars in personal property are being towed across the nation. Personal property can range from personal luggage to private watercrafts. These items can be towed by vehicles ranging from diesel vehicles to small luxury SUV's. Thus, the towing of personal belongings is a common way to transfer massive amounts of goods from one location to another. When towing items on a trailer, the hitch ball mount typically is secured in the trailer hitch ball mount box with a pin. This pin is secured or otherwise prevented from vibrating out of the hitch ball mount by means of a mechanical pin or by a key-based locking mechanism. The insertion of the pin, and the securing of the pin, is the necessary beginning to completing the towing system. To further describe the system, the trailer is attached and secured to the hitch ball mount, via a coupler. After the coupler has been attached to the hitch ball mount, the towing system may be further secured with safety chains, and other locking devices.

A reliable hitch ball mount assembly is valuable for safety as well as security.

### SUMMARY

A hitch ball mount assembly includes a biometrically-actuated locking mechanism. The biometrically-actuated locking mechanism cooperates with a mechanical engagement or locking mechanism to lock or unlock the hitch ball mount assembly to an associated vehicle mount in response to detection of an authorized user.

One aspect of the invention relates to a hitch ball mount assembly that includes a body having a hitch end and a receiver end, the body defining at least one pin aperture adjacent the receiver end, an engagement mechanism coupled to the body, the engagement mechanism configured to releasably engage the hitch ball mount assembly to an associated ball mount box, and a biometric actuation device operatively coupled to the engagement mechanism and configured to provide an actuation signal to the engagement mechanism.

Another aspect of the invention relates to a hitch ball mount assembly that includes a body having a proximal end and a distal end, the body defining a pair of pin apertures adjacent the distal end, a locking mechanism coupled to the body, the locking mechanism configured to releasably lock the hitch ball mount assembly to an associated vehicle mount, and a biometric actuation device configured to provide an actuation signal to the locking mechanism in response to detecting a biometric actuation by an authorized user.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of features of the other embodiments.

### BRIEF DESCRIPTION OF THE DRAWINGS

Many aspects of the invention can be better understood with reference to the following drawings. The components of the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an exploded perspective view of a hitch ball mount assembly in proximity to an associated hitch ball mount box;

FIG. 2 is an enlarged view of a portion of FIG. 1 showing the engagement mechanism;

FIG. 3 is a perspective view of the ball hitch mount assembly in a locked position relative to an associated hitch ball mount box;

FIG. 4 is a perspective view of the ball hitch mount assembly in an unlocked position relative to an associated hitch ball mount box;

FIG. 5 is a front end view of the hitch ball mount assembly in accordance with an aspect of the present invention

FIG. 6 is a cross sectional view of FIG. 4 taken along line A-A FIG. 7 is a cross sectional view of FIG. 6 taken along line B-B showing the locking pins in an unlocked position;

FIG. 8 is a cross sectional view of FIG. 5 taken along line C-C; and

FIG. 9 is an enlarged view of a portion of FIG. 8 showing a portion of the engagement mechanism.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

The components that are used to lock a trailer to the hitch ball mount are used for multiple purposes. The intents of the components have been used to prevent locking latches from disengagement and to deter theft. When the vehicle is moving or towing, the components are to prevent disengagement of vital mechanical parts. Yet, when the action of towing is not in process, it becomes important that security is present.

As noted before, millions of dollars of personal property are being towed across the nation. A person towing their personal goods will not consistently have visual contact of their towing goods. Thus, towing trailers may be secured by means of keyed locking devices that range from steel laminated padlocks to stainless steel bodied locks. Securing the link between the trailer and the hitch ball mount is not enough. The securing of the hitch ball mount to the hitch itself is a very important aspect of the towing system.

Theft of a trailer typically is due to a weak link in the towing system. If a pin is used to lock the coupler, then that may be the weakest point in the system because the coupler pin does not have the necessary locking component to prevent an individual from removing the pin, and taking the trailer by another towing vehicle. The same situation may arise if the hitch ball mount is secured only by a non-keyed locking pin to the hitch ball mount box. An individual can remove the pin with ease and slide the hitch ball mount that is still attached to the trailer and tows the goods away. In another situation, suppose the trailer is disconnected from the hitch ball mount, and is safely secured from being towed away from another person. The hitch ball mount is secured in the hitch ball mount box by a non-keyed locking pin. Again, without a keyed locking pin, an individual can easily remove a $30-$40 hitch ball mount and steal or replace the existing hitch ball mount with a defective hitch ball mount. In turn, a $30-$40 hitch ball mount may leave personal property in jeopardy or stranded.

Yet, the hitch ball mount may be secured to the hitch ball mount box by means of a keyed locking pin. Another series of situations can occur. Keys can be easily mixed up with other keys or lost in these towing trips. It is important to note that there are other locking components used in the towing system and different keys may be used with different locking components. Keys, in turn, can be copied by unwanted people. It is also necessary to note that lock manufacturers tend to produce batches of locks with the same key cuts. Thus, if a neighbor shops at the same store that bought the same lock, the probability will be high that somebody else who also tows will buy the same lock with the same key cut. Thus, the sense of security decreases.

In turn, there is a need for a product that can be made to increase security and customization to the end user. Thus, aspects of the present invention provide customization by the end user and increase of security by generating an assembly that combines a biometric scanning device that will relay information to mechanical components that are within towing hitch ball mount, into a single working assembly.

Aspects of the invention relate to integrating a mechanical locking mechanism within the hitch ball mount. Aspects of the invention also enable the user to avoid using a keyed locking mechanism to connect the hitch ball mount to the hitch ball mount box. Therefore, the assembly promotes reducing the need to have another key.

Furthermore, aspects of the invention allow for end user customization. The end user can specify exactly who may unlock the hitch ball mount from the hitch ball mount box, by means of biometric information. Therefore, the end user will not having to worry about having individuals with the same key cut or replicating the key.

In view of the foregoing, the disclosed technology relates to a hitch ball mount assembly equipped with a biometric actuation device. The biometric actuation device is operatively coupled to an engagement mechanism that is configured to actuate a pair of locking pins upon detection of a biometric actuation by an authorized user.

Aspects of the disclosed technology are directed to a hitch ball assembly having an integrated biometric actuation device with mechanical locking parts that are within the hitch ball mount assembly. The biometric actuation device is configured to relay information to activate a driving device or not. In turn, the driving device can be mechanically connected to a cam that will position the locking pins in the lock or unlock position. The locking pins can ride in a locking mechanism housing and move axially as the cam is moved by means of the driving device. In turn, the housing that allows for the pins to move axially relative to the movement of the cam will be position and secured inside the hitch ball mount. The locking pins are used in replacement of existing hitch pins that secure the hitch ball mount to an associated hitch ball mount box.

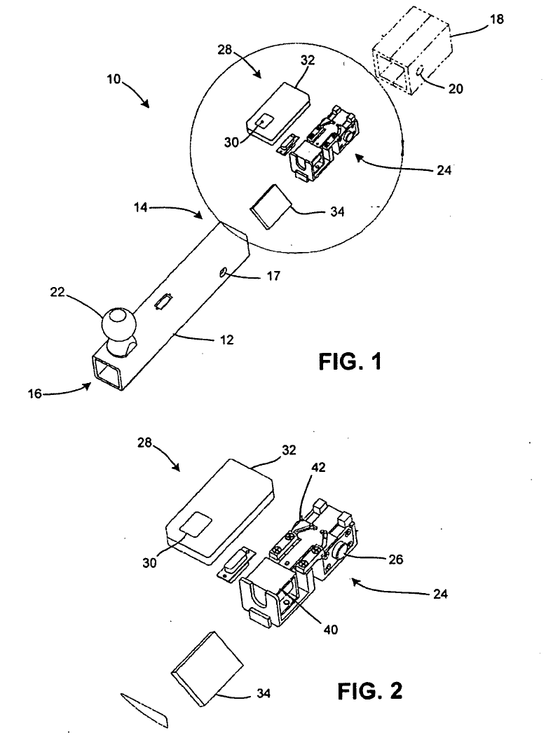

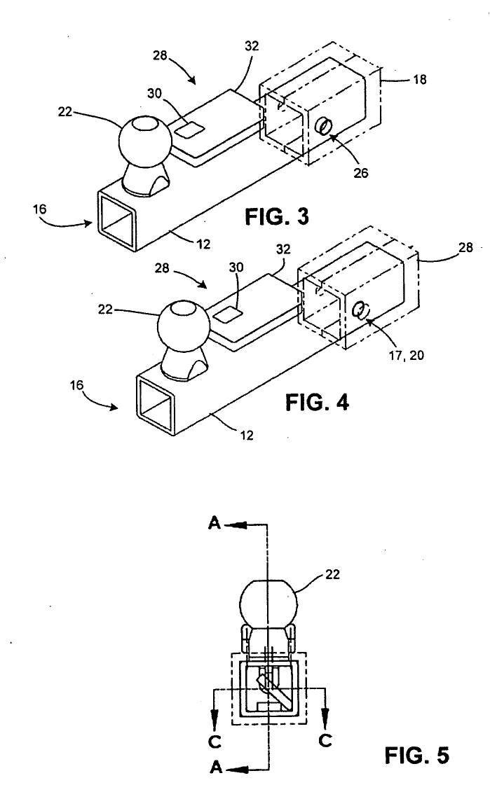

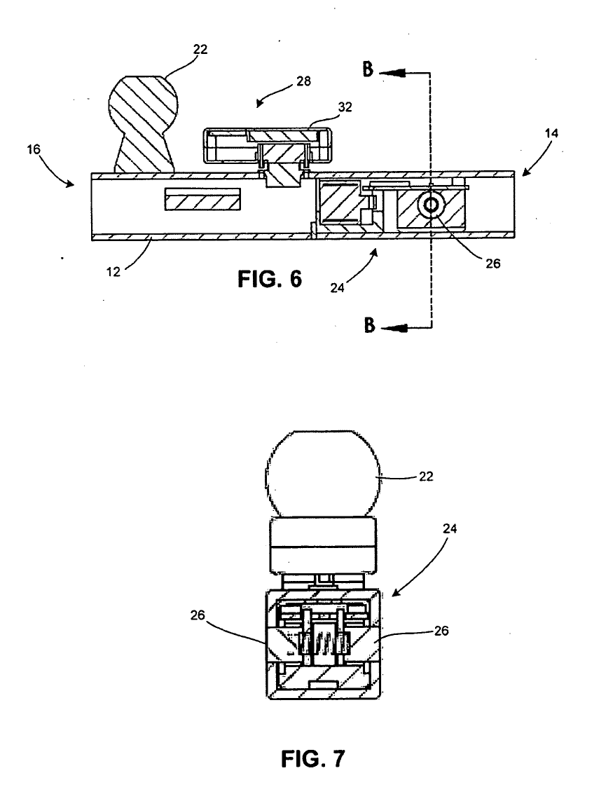

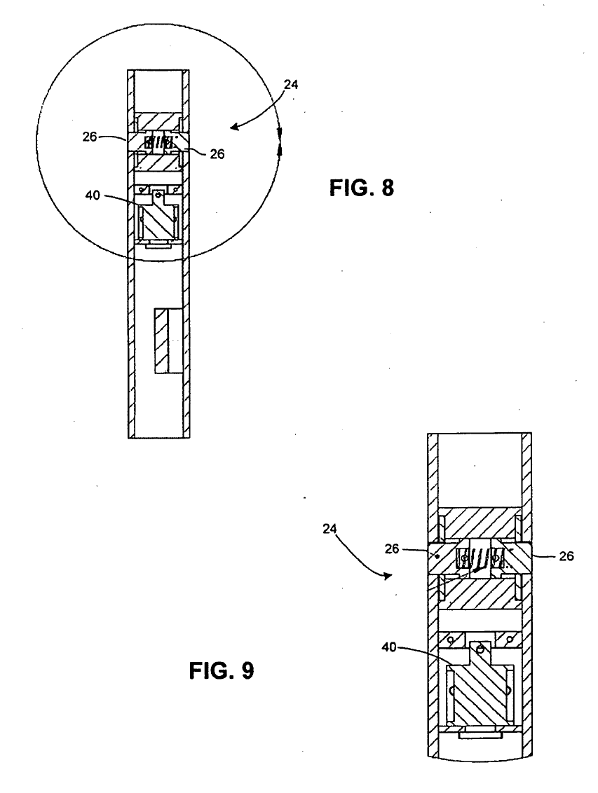

Referring to FIGS. 1-9, a hitch ball mount assembly 10 comprises a body 12 having a receiver end 14 (also referred to as a proximal end in relation to a vehicle (not shown)) and a hitch end 16 (also referred to as a distal end in relation to a vehicle (not shown)). The receiver end includes or otherwise defines a pair of apertures 17. The receiver end 14 is configured to cooperate with and engage a receiver or ball mount box 18 (also referred to as a vehicle mount) associated with a vehicle to be used to tow a secondary vehicle, e.g. a trailer. The ball mount box 18, which typically is configured to receive the receiver end 14 of the hitch ball mount assembly, includes or otherwise defines a pair of apertures 20 that are configured to align with the apertures 17 of the hitch ball mount assembly when the hitch ball mount assembly 10 is disposed within the ball mount box 18. In the illustrated embodiment, the hitch ball mount assembly 10 includes a hitch ball 22, which may be engaged by a coupler associated with a trailer to be towed. It will be appreciated that the invention is not limited to any particular hitch ball configuration (or even to use of a hitch ball coupling mechanism).

The hitch ball mount assembly 10 includes an engagement mechanism (also referred to as a locking mechanism) 24 operatively coupled to the body 12, e.g., coupled to the body by press fit, by fastener, by welding into position or by other suitable means. In a preferred embodiment, the engagement mechanism 24 is disposed at least partially within the body 12. The engagement mechanism 24 is configured to releasably engage the hitch ball mount assembly to the ball mount box 18 via one or more locking pins 26, which, when in a locked position, resiliently extend through apertures 17 and 20, thereby locking the ball mount assembly to the associated ball mount box.

The engagement mechanism 24 is operatively coupled to a biometric actuation device 28 (also referred to as a biometric system or biometric device). The biometric actuation device 28 includes, for example, a biometric scanner 30 disposed within a housing 32. The biometric actuation device is configured to detect a feature of an authorized user, e.g., the touch or fingerprint of an authorized user in the case of a finger detection-type of biometric scanner. The biometric actuation device 28 may be operatively coupled to a secondary chip board 34 which, in turn, may relay an actuation signal to the engagement mechanism 24. Upon receipt of an appropriate actuation signal by the biometric actuation device, the engagement mechanism may be actuated to automatically unlock or otherwise release engagement of the hitch ball mount assembly to the ball mount box. The hitch ball mount assembly may also be configured to lock the hitch ball mount assembly to the associated ball mount box upon receipt of a second actuation signal response to detection of a biometric actuation by an authorized user.

In a preferred embodiment, the engagement or locking mechanism 24 includes a linear actuator 40, a camming device (also referred to simply as a cam) 42 and a pair of locking pins 26, e.g., axially spring-loaded pins. Upon detection of an authorized biometric actuation, received via the biometric scanner, an actuation signal is relayed to the engagement system, e.g., via a secondary chip board. The actuation signal triggers the linear actuator 40, which then actuates the cam 42, thereby causing the locking pins 26 to recess back into an unlocked position to release the hitch ball mount assembly from the ball mount box. It will be appreciated that the engagement mechanism is not limited to the particular linear actuator and cam arrangement described above. Rather, other engagement mechanisms may be disposed as long as the mechanism is operable to receive an actuation signal from a biometric actuation device, and to provide an actuation signal which releases a pair of pins or other engagement members. Because the pins are configured to be axially spring-loaded, the default position for the hitch ball mount assembly via the engagement mechanism is to be engaged.

In a preferred embodiment, the biometric sensor is configured to recognize the touch or fingerprint of an authorized user or users. It will be appreciated that other biometric actuation systems and/or scanners may be employed without departing from the scope of the present invention.

Biometric markers used for authentication and identification of authorized users may include measurements of unique visible features such as fingerprints, hand and/or face geometry, and retinal and/or iris patterns, as well as the measurement of unique behavioral responses such as the recognition of vocal patterns and the analysis of hand movements. The use of each of these biometric markers requires a device to make the biological measurement and process it in electronic form. The device may measure and compare the unique spacing of the features of a person's face or hand and compare the measured value with a value stored in memory or a storage device component (e.g., disk drive, volatile or non-volatile memory, etc.) associated with the device. Where the measured values match the stored values, the person is identified or authorized.

Several types of technologies are used in biometric identification of superficial anatomical traits. For example, biometric fingerprint identification systems may require the individual being identified to place his or her finger on a visual scanner. The scanner reflects light off of the person's finger and records the way the light is reflected off of the ridges that make up the fingerprint. Hand and face identification systems use scanners or cameras to detect the relative anatomical structure and geometry of the person's face or hand. Different technologies are used for biometric authentication using the person's eye. For retinal scans, a person would place his or her eye close to or upon a retinal scanning device. The scanning device may scan the retina to form an electronic version of the unique blood vessel pattern in the retina. An iris scan records the unique contrasting patterns of a person's iris.

Still other types of technologies are used for biometric identification of behavioral traits. Voice recognition systems generally use a telephone or microphone to record the voice pattern of the user received. Usually the user will repeat a standard phrase, and the device compares the measured voice pattern to a voice pattern stored in the system. Signature authentication is a more sophisticated approach to the universal use of signatures as authentication. Biometric signature verification not only makes a record of the pattern of the contact between the writing utensil and the recording device, but also measures and records speed and pressure applied in the process of writing.

It will be appreciated that the provision of the hitch ball mount assembly equipped with a biometric actuation device and a cooperative locking mechanism provides numerous advantages. For example, the hitch ball mount assembly provides improved safety and security, thereby reducing the chances of the hitch ball mount assembly becoming inadvertently or through an act of theft becoming disengaged from the ball mount box. Another advantage relates to the provision of automatic unlocking upon detection of an authorized user without requiring the user to physically manipulate locking pins or keyed locking devices.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A hitch ball mount assembly comprising:
a body having a hitch end and a receiver end, the body defining at least one pin aperture adjacent the receiver end;
an engagement mechanism coupled to the body, the engagement mechanism configured to releasably engage the hitch ball mount assembly to an associated ball mount box; and
a biometric actuation device operatively coupled to the engagement mechanism and configured to provide an actuation signal to the engagement mechanism.

2. The hitch ball mount assembly according to claim 1, wherein the biometric actuation device includes a biometric scanner.

3. The hitch ball mount assembly according to claim 2, wherein the biometric scanner is configured to detect touch of an authorized user.

4. The hitch ball mount assembly according to claim 2, wherein the biometric scanner is configured to detect a fingerprint of an authorized user.

5. The hitch ball mount assembly according to claim 1, wherein the biometric actuation device is configured to:
detect biometric actuation by an authorized user; and
provide an actuation signal to the engagement mechanism to facilitate disengagement of the engagement mechanism.

6. The hitch ball mount assembly according to claim 1, wherein the biometric actuation device is configured to:
detect biometric actuation by an authorized user; and
provide an actuation signal to the engagement mechanism to facilitate engagement of the engagement mechanism.

7. The hitch ball mount assembly according to claim 1, wherein the engagement mechanism includes a pair of locking pins configured to releasably engage the hitch ball mount assembly to an associated ball mount box.

8. The hitch ball mount assembly according to claim 7, wherein the locking pins are axially spring loaded.

9. The hitch ball mount assembly according to claim 8, wherein the locking pins are configured to extend through pin apertures of the body when in a locked position.

10. The hitch ball mount assembly according to claim 1, wherein the engagement mechanism includes a linear actuator, a cam and locking pins, and a cam, wherein the linear actuator is configured to actuate the cam to cam the locking pins into an unlocked position.

11. The hitch ball mount assembly according to claim 1, wherein the biometric actuation device is configured to actuate the linear actuator in response to detecting actuation by an authorized user.

12. A hitch ball mount assembly comprising:
a body having a proximal end and a distal end, the body defining a pair of pin apertures adjacent the distal end;
a locking mechanism coupled to the body, the locking mechanism configured to releasably lock the hitch ball mount assembly to an associated vehicle mount; and
a biometric actuation device configured to provide an actuation signal to the locking mechanism in response to detecting a biometric actuation by an authorized user.

13. The hitch ball mount assembly according to claim 12, wherein the locking mechanism includes a pair of locking pins that are movable between locked and unlocked positions in response to an actuation signal from the biometric actuation device.

14. The hitch ball mount assembly according to claim 12, wherein the locking mechanism includes a linear actuator coupled to a camming device and a pair of locking pins, wherein the linear actuator is movable to cam the locking pins into an unlocked state in response to an actuation signal from the biometric actuation device.

15. The hitch ball mount assembly according to claim 12, wherein the locking mechanism includes a linear actuator coupled to a camming device and a pair of locking pins, wherein the linear actuator is movable to cam the locking pins into a locked state in response to an actuation signal from the biometric actuation device.

16. A hitch ball mount assembly comprising a biometrically-actuated locking mechanism, wherein a biometric actuation device relays locking/unlocking information to a mechanical locking device to lock or unlock the hitch ball mount assembly in response to detection of a biometric actuation by an authorized user.
